(19) United States
(12) Patent Application Publication
(10) Pub. No.: US 2017/0305340 A1
(43) Pub. Date: Oct. 26, 2017

(54) SAFETY ALERT SYSTEM

(71) Applicants: Sandra Rose, Cheektowaga, NY (US); Tracy Schwenk, Ft. Lauderdale, FL (US)

(72) Inventors: Sandra Rose, Cheektowaga, NY (US); Tracy Schwenk, Ft. Lauderdale, FL (US)

(21) Appl. No.: 15/137,429

(22) Filed: Apr. 25, 2016

(51) Int. Cl. B60Q 9/00; B60N 2/00; B60R 22/48; B60R 22/10

(52) U.S. Cl. CPC B60Q 9/00; B60R 22/48; B60R 22/105; B60N 2/002; B60R 2022/4816; B60R 2022/4866

(57) ABSTRACT

A safety alert system includes a child seat that may be positioned within a vehicle. The child seat has a plurality of belts and each of the belts may restrain a child in the child seat. A remote unit may be retrofitted to a dome light of the vehicle. The remote unit generates an alarm sequence when a door of the vehicle is opened. A base unit is removably coupled to the belts on the child seat and the base unit is in electrical communication with the remote unit. The base unit emits an audible alarm when the remote unit generates the alarm sequence. Thus, the base unit may prevent the child from being inadvertently left unattended in the vehicle.

### BACKGROUND OF THE DISCLOSURE

### Field of the Disclosure

The disclosure relates to safety devices and more particularly pertains to a new safety device for preventing a child from being inadvertently left unattended in a vehicle.

### SUMMARY OF THE DISCLOSURE

An embodiment of the disclosure meets the needs presented above by generally comprising a child seat that may be positioned within a vehicle. The child seat has a plurality of belts and each of the belts may restrain a child in the child seat. A remote unit may be retrofitted to a dome light of the vehicle. The remote unit generates an alarm sequence when a door of the vehicle is opened. A base unit is removably coupled to the belts on the child seat and the base unit is in electrical communication with the remote unit. The base unit emits an audible alarm when the remote unit generates the alarm sequence. Thus, the base unit may prevent the child from being inadvertently left unattended in the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a safety alert system according to an embodiment of the disclosure.

FIG. 2 is a perspective view of an embodiment of the disclosure.

FIG. 3 is a schematic view of an embodiment of the disclosure.

FIG. 4 is a perspective in-use view of an embodiment of the disclosure.

FIG. 5 is a perspective in-use view of an alternative embodiment of the disclosure.

FIG. 6 is a schematic drawing of an embodiment of the disclosure.

### DESCRIPTION OF THE PREFERRED EMBODIMENT

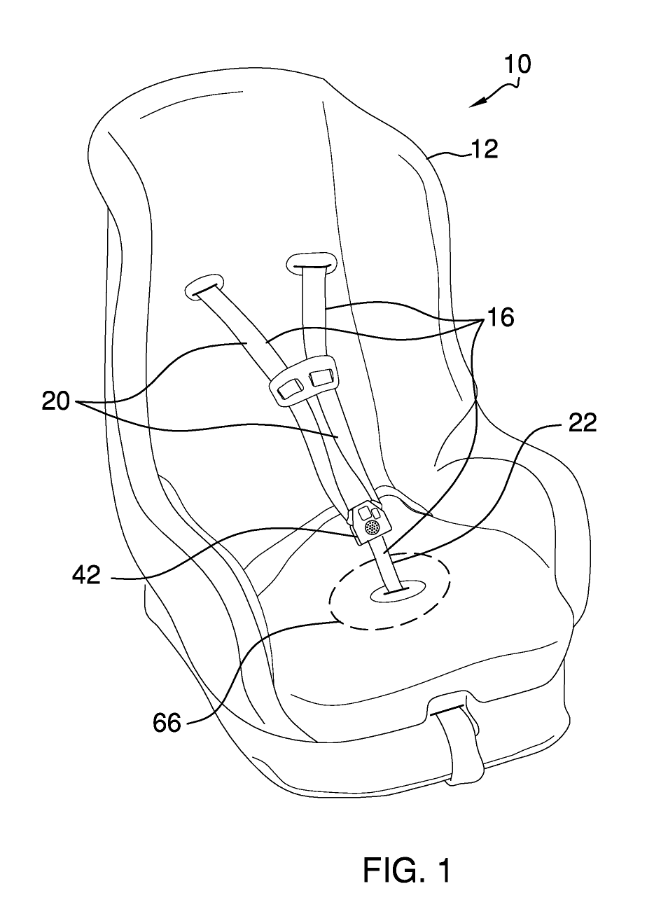

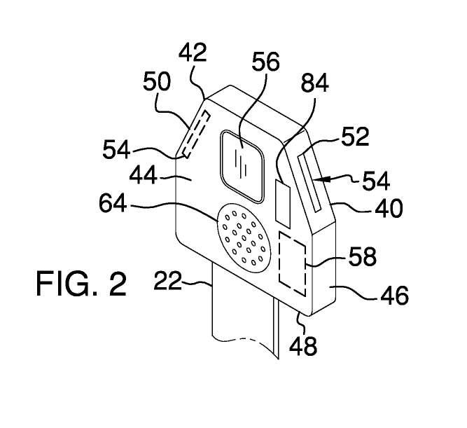

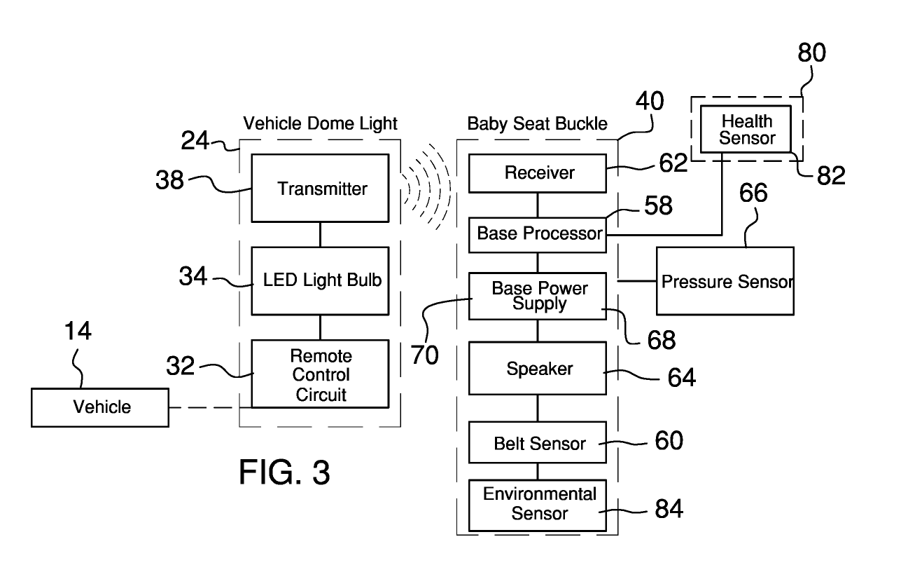

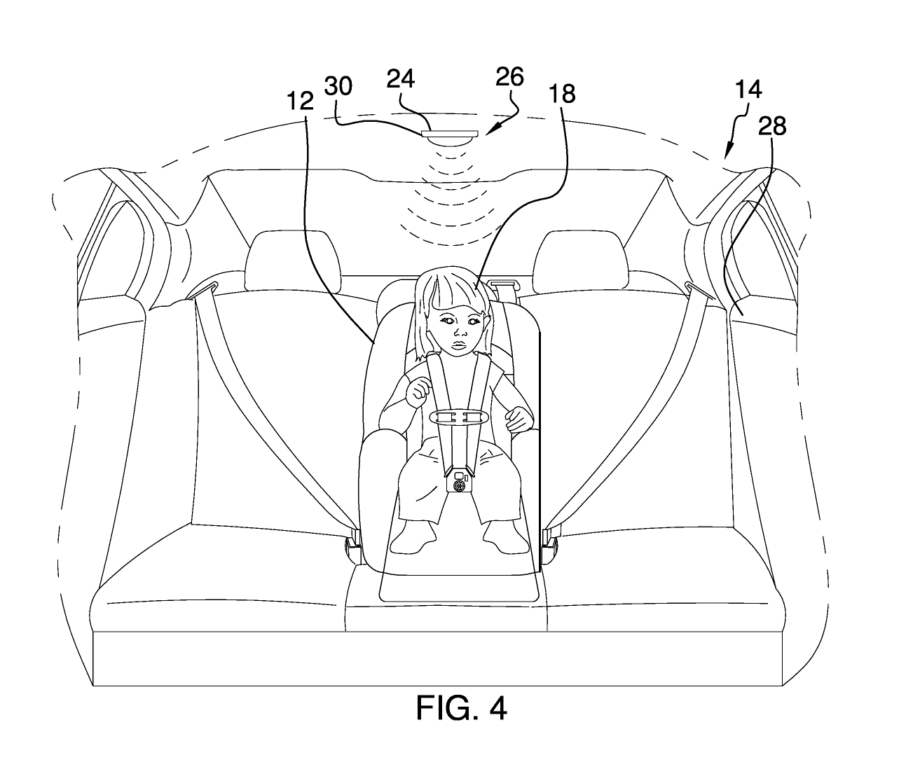

With reference now to the drawings, and in particular to FIGS. 1 through 6 thereof, a new safety device embodying the principles and concepts of an embodiment of the disclosure and generally designated by the reference numeral 10 will be described.

As best illustrated in FIGS. 1 through 6, the safety alert system 10 generally comprises a child seat 12 that may be positioned within a vehicle 14. The child seat 12 has a plurality of belts 16 and each of the belts 16 may restrain a child 18 in the child seat 12. The plurality of belts 16 includes a top set of belts 20 and a lower belt 22. The vehicle 14 may comprise a passenger vehicle or the like.

A remote unit 24 is provided and the remote unit 24 may be retrofitted to a dome light 26 of the vehicle 14. The remote unit 24 generates an alarm sequence when a door 28 of the vehicle 14 is opened. The remote unit 24 comprises a remote housing 30 that replaces the dome light 26 or is positioned within the dome light 26. A remote control circuit 32 is positioned within the remote housing 30. The remote control circuit 32 is in electrical communication with the vehicle 14 thereby facilitating the remote control circuit 32 to detect when the vehicle door 28 has been opened. The remote control circuit 32 generates the alarm sequence when the vehicle door 28 is opened and the vehicle door 28 may be a driver's side door or a passenger's side door. Alternatively, the remote control circuit 32 may be positioned at any location within the vehicle 14.

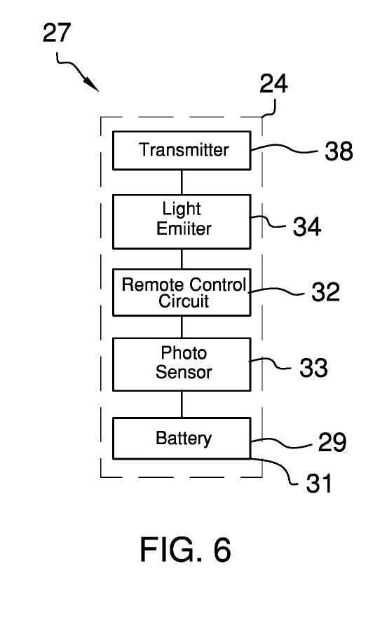

In an alternative embodiment 27 as shown in FIG. 6, the remote unit 24 may include a remote power supply 29. The remote power supply 29 may be electrically coupled to the remote control circuit 32. The remote power supply 29 may comprise at least one battery 31. A photo sensor 33 may be provided and the photo sensor 33 may be electrically coupled to the remote control circuit 32. A fastener may be provided and the fastener may be coupled to the remote housing 30. The fastener may engage the dome light 26 thereby removably retaining the remote housing 30 on an existing dome light 26. The fastener may comprise an adhesive strip, a clip or any conventional fastener.

A light emitter 34 is positioned within the remote housing 30. The light emitter 34 is electrically coupled to the remote control circuit 32 such that the light emitter 34 emits light when the remote control circuit 32 generates the alarm sequence. The light emitter 34 may comprise an LED or the like. A transmitter 38 is positioned within the remote housing 30. The transmitter 38 is electrically coupled to the remote control circuit 32 such that the transmitter 38 transmits an alarm signal when the remote control circuit 32 generates the alarm sequence. The transmitter 38 may comprise a radio frequency transmitter or the like.

A base unit 40 is removably coupled to the belts 16 on the child seat 12. The base unit 40 is in electrical communication with the remote unit 24. The base unit 40 emits an audible alarm when the remote unit 24 generates the alarm sequence. Thus, the base unit 40 may prevent the child 18 from being inadvertently left unattended in the vehicle 14.

The base unit 40 comprises a base housing 42 that has a front side 44 and a perimeter edge 46. The perimeter edge 46 has a bottom side 48, a first lateral side 50 and a second lateral side 52. The lower belt 22 is coupled to the bottom side 48 and each of the first lateral side 50 and the second lateral side 52 has an associated one of a pair of slots 54 extending therethrough. Each of the slots 54 insertably receives an associated one of the top set of belts 20. Thus, each of the top set of belts 20 is removably coupled to the lower belt 22 such that the base housing 42 restrains the child 18 in the child seat 12.

A release 56 is coupled to the front side 44 of the base housing 42 such that the release 56 may be manipulated. The release 56 releases each of the top set of belts 20 from the slots 54 when the release 56 is manipulated. Thus, the child 18 may be removed from the child seat 12. The base unit 40 engages each of the top set of belts 20 through any conventional mechanical means relating to seat belts.

A base processor 58 is positioned within the base housing 42 and the base processor 58 may comprise an electronic processor or the like. A belt sensor 60 is positioned within the base housing 42 such that the belt sensor 60 detects when the top set of belts 20 is coupled to the base housing 42. The belt sensor 60 actuates and de-actuates the base processor 58 when the belt sensor 60 detects the top set of belts 20 is respectively coupled to and released from the base housing 42. The belt sensor 60 may comprise an electronic sensor or the like.

A receiver 62 is positioned within the base housing 42 and the receiver 62 is electrically coupled to the base processor 58. The receiver 62 is in electrical communication with the transmitter 38 such that the receiver 62 communicates the alarm signal to the base processor 58. The receiver 62 may comprise a radio frequency receiver or the like. The receiver 62 may be in electrical communication with an extrinsic communications network such as a cell phone network, a vehicle computer system or other extrinsic communications network. A speaker 64 is coupled to the front side 44 of the base housing 42 and the speaker 64 is electrically coupled to the base processor 58. The speaker 64 emits an audible alarm when the base processor 58 receives the alarm signal thereby inhibiting the child 18 from being left unattended in the vehicle 14.

A pressure sensor 66 may be provided and the pressure sensor 66 may be positioned within the child seat 12. Thus, the pressure sensor 66 detects when the child 18 is sitting in the child seat 12. The pressure sensor 66 is electrically coupled to the base processor 58. The pressure sensor 66 de-actuates the base processor 58 when the pressure sensor 66 does not detect the child 18 in the child seat 12. A base power supply 68 is positioned within the base housing 42. The base power supply 68 is electrically coupled to the base processor 58. The base power supply 68 comprises at least one battery 70.

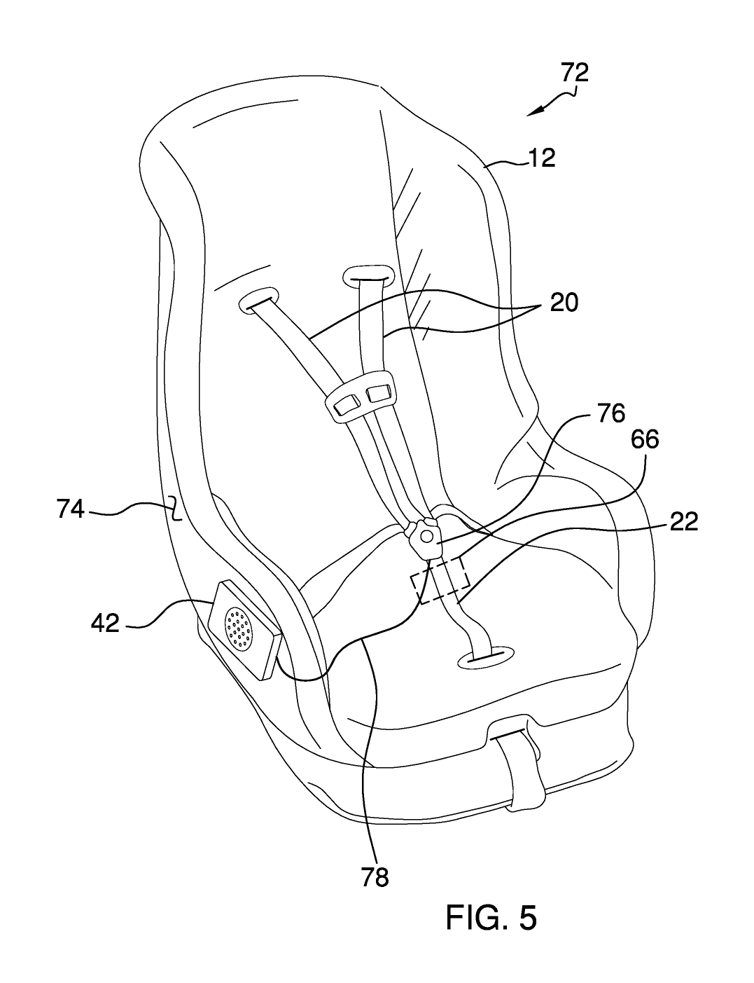

In an alternative embodiment 72 as shown in FIG. 5, the child seat 12 has an exterior surface 74 and a buckle 76 may be coupled to the lower belt 22. The base housing 42 may be coupled to the exterior surface 74. A conductor 78 may be provided and the conductor 78 may be electrically coupled between the belt sensor 60 and the buckle 76. Thus, the belt sensor 60 detects when the top set of belts 20 is coupled to the buckle 76.

A bracelet 80 may be provided and the bracelet 80 may be worn by the child. A health sensor 82 may be attached to the bracelet 80. Thus, the health sensor 82 is in physical contact with the child when the bracelet 80 is worn. The health sensor 82 may comprise an LED, optical sensors or other sensors commonly used to monitor physiological aspects of a human being. Thus, the health sensor 82 may detect temperature, respiration and heart rate of the child. The health sensor 82 is in electrical communication with the base processor 58 via a conductor or the like.

An environmental sensor 84 may be coupled to the base housing 42. The environmental sensor 84 may be electrically coupled to the base processor 58. The environmental sensor 84 may comprise an electrical sensor capable of detecting temperature, oxygen levels, carbon dioxide levels or other gases. Thus, the environmental sensor 84 monitors the environment within the vehicle 14.

In use, the child 18 is placed in the child seat 12 and each of the top set of belts 20 is coupled to the base housing 42. The speaker 64 emits the audible alarm when the vehicle door 28 is opened thereby inhibiting the child 18 from being left unattended in the vehicle 14. The speaker 64 does not emit the audible alarm if the belt sensor 60 does not detect that the top set of belts 20 is coupled to the base housing 42. The pressure sensor 66 prevents the base processor 58 from being de-actuated when the pressure sensor 66 detects the child 18 is in the child seat 12 and the belt sensor 60 does not detect that the top set of belts 20 is coupled to the base housing 42.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A safety alert system comprising:
a child seat configured to be positioned within a vehicle, said child seat has a plurality of belts, each of said belts being configured to restrain a child in said child seat;
a remote unit configured to be retrofitted to a dome light of the vehicle, said remote unit generating an alarm sequence when a door of the vehicle is opened; and
a base unit being removably coupled to said belts on said child seat, said base unit being in electrical communication with said remote unit, said base unit emitting an audible alarm when said remote unit generates said alarm sequence wherein said base unit is configured to prevent the child from being inadvertently left unattended in the vehicle.

2. The system according to claim 1, wherein said remote unit comprises:
a remote housing being configured to replace the dome light; and
a remote control circuit being positioned within said remote housing, said remote control circuit being configured to be in electrical communication with the vehicle thereby facilitating said remote control circuit to detect when the vehicle door has been opened, said remote control circuit generating the alarm sequence when the vehicle door is opened.

3. The system according to claim 2, further comprising a light emitter being positioned within said remote housing, said light emitter being electrically coupled to said remote control circuit such that said light emitter emits light when said remote control circuit generates said alarm sequence.

4. The system according to claim 3, further comprising a transmitter being positioned within said remote housing, said transmitter being electrically coupled to said remote control circuit such that said transmitter transmits an alarm signal when said remote control circuit generates said alarm sequence.

5. The system according to claim 1, wherein:
said plurality of belts includes a top set of belts and a lower belt; and
said base unit comprises a base housing having a front side and a perimeter edge, said perimeter edge having a bottom side, a first lateral side and a second lateral side, said lower belt being coupled to said bottom side, each of said first lateral side and said second lateral side having an associated one of a pair of slots extending therethrough, each of said slots insertably receiving an associated one of said top set of belts such that each of said top set of belts are removably coupled to said lower belt wherein said base housing is configured to restrain the child in the child seat.

6. The system according to claim 5, further comprising a release being coupled to said front side wherein said release is configured to be manipulated, said release releasing each of said top set of belts from said slots when said release is manipulated thereby facilitating the child to be removed from said child seat.

7. The system according to claim 5, further comprising:
a base processor being positioned within said base housing; and
a belt sensor being positioned within said base housing such that said belt sensor detects when said top set of belts is coupled to said base housing, said belt sensor actuating and de-actuating said base processor when said belt sensor detects said top set of belts being respectively coupled to and released from said base housing.

8. The system according to claim 7, further comprising:
a transmitter transmitting an alarm signal; and
a receiver being positioned within said base housing, said receiver being in electrical communication with said base processor, said receiver being in electrical communication with said transmitter such that said receiver communicates said alarm signal to said base processor.

9. The system according to claim 8, further comprising a speaker being coupled to said front side, said speaker being electrically coupled to said base processor wherein said speaker is configured to emit an audible alarm when said base processor receives said alarm signal thereby inhibiting the child from being left unattended in the vehicle.

11. The system according to claim 5, further comprising a base power supply being positioned within said base housing, said base power supply being electrically coupled to said base processor, said base power supply comprising at least one battery.

12. A safety alert system comprising:
a child seat configured to be positioned within a vehicle, said child seat having a plurality of belts, each of said belts being configured to restrain a child in said child seat, said plurality of belts including a top set of belts and a lower belt;
a remote unit configured to be retrofitted to a dome light of the vehicle, said remote unit generating an alarm sequence when a door of the vehicle is opened, said remote unit comprising:
a remote housing being configured to replace the dome light,
a remote control circuit being positioned within said remote housing, said remote control circuit being configured to be in electrical communication with the vehicle thereby facilitating said remote control circuit to detect when the vehicle door has been opened, said remote control circuit generating the alarm sequence when the vehicle door is opened,
a light emitter being positioned within said remote housing, said light emitter being electrically coupled to said remote control circuit such that said light emitter emits light when said remote control circuit generates said alarm sequence,
a transmitter being positioned within said remote housing, said transmitter being electrically coupled to said remote control circuit such that said transmitter transmits an alarm signal when said remote control circuit generates said alarm sequence; and
a base unit being removably coupled to said belts on said child seat, said base unit being in electrical communication with said remote unit, said base unit emitting an audible alarm when said remote unit generates said alarm sequence wherein said base unit is configured to prevent the child from being inadvertently left unattended in the vehicle, said base unit comprising:
a base housing having a front side and a perimeter edge, said perimeter edge having a bottom side, a first lateral side and a second lateral side, said lower belt being coupled to said bottom side, each of said first lateral side and said second lateral side having an associated one of a pair of slots extending therethrough, each of said slots insertably receiving an associated one of said top set of belts such that each of said top set of belts are removably coupled to said lower belt wherein said base housing is configured to restrain the child in the child seat,
a release being coupled to said front side wherein said release is configured to be manipulated, said release releasing each of said top set of belts from said slots when said release is manipulated thereby facilitating the child to be removed from said child seat,
a base processor being positioned within said base housing,
a belt sensor being positioned within said base housing such that said belt sensor detects when said top set of belts is coupled to said base housing, said belt sensor actuating and de-actuating said base processor when said belt sensor detects said top set of belts being respectively coupled to and released from said base housing,
a receiver being positioned within said base housing, said receiver being in electrical communication with said base processor, said receiver being in electrical communication with said transmitter such that said receiver communicates said alarm signal to said base processor,
a speaker being coupled to said front side, said speaker being electrically coupled to said base processor wherein said speaker is configured to emit an audible alarm when said base processor receives said alarm signal thereby inhibiting the child from being left unattended in the vehicle, and
a base power supply being positioned within said base housing, said base power supply being electrically coupled to said base processor, said base power supply comprising at least one battery.
